(19) United States
(12) Patent Application Publication
(10) Pub. No.: US 2006/0030184 A1
(43) Pub. Date: Feb. 9, 2006

(54) Multiple terminal connector

(75) Inventor: Ryo Sasaki, Tokyo (JP)

Correspondence Address: DARBY & DARBY P.C., P. O. BOX 5257, NEW YORK, NY, 10150-5257, US

(73) Assignee: SMK CORPORATION, Tokyo (JP)

(21) Appl. No.: 11/178,078

(22) Filed: Jul. 8, 2005

(30) Foreign Application Priority Data
Aug. 3, 2004 (JP) 2004-227091

(51) Int. Cl. H01R 13/44

(52) U.S. Cl. 439/131

(57) ABSTRACT

The present invention is a multi-terminal connector in which an insertion body can be inserted or removed. The insertion body is connected to or disconnected from an internal terminal connection part. With the insertion or removal of the insertion body, a shutter inside an insertion opening opens or closes and a lock spring moves up and down. The lock spring includes a base affixed to the top surface of a housing and a flat spring part extending from both sides of the base. The flat spring part includes a protruding part and a latching surface protruding inward. The protruding part is bent downward and protrudes to the inside of the insertion opening through a cut-out in the housing. As a result, an internal terminal is protected by preventing the insertion of an incompatible insertion body, while reducing the extended areas on both sides to achieve a smaller size.

### INCORPORATION BY REFERENCE

The present application claims priority under 35 U.S.C. §119 to Japanese Patent Application No. 2004-227091 filed on Aug. 3, 2004. The content of the application is incorporated herein by reference in its entirety.

### FIELD OF THE INVENTION

The present invention relates generally to a multi-terminal connector for inserting and connecting to an insertion body such as an IC (integrated circuit) card or plug having a multi-terminal. More specifically, the present invention relates to a multi-terminal connector which prevents the insertion of incompatible insertion bodies and which protects the internal terminal.

### BACKGROUND OF THE INVENTION

An example of a multi-terminal connector of the prior art is shown in FIG. 6 (Japanese Laid-Open Patent Publication Number 11-251019). In FIG. 6, there is a terminal connection part 11 provided at the center of an H-shaped frame 10. A plurality of connection terminals 12 provided on this terminal connection part 11 has connection ends for connecting to a card 24 as the insertion body. These connection ends of connection terminals 12 protrude towards an arm 25 of said frame 10. The protruding parts on the other side of connection terminals 12 are connected with a circuit board or the like.

A shutter 13 which can move forward and back is placed at the protruding portion on the arm 25 side of this connection terminal 12. Connection terminals 12 can be inserted into or removed from pin insertion holes 14 of shutter 13. There is a spring 15 interposed between a spring cavity 17 of shutter 13 and a spring cavity 16 of terminal connection part 11. Spring 15 urges shutter 13 outward so that the ends of connection terminals 12 are hidden within pin insertion holes 14.

Lock springs 18 are provided on both sides of frame 10. In the usual condition, a hooking part 19 of lock spring 18 engages with a hooking hole 20 on the side surfaces of shutter 13. In addition, a contact part 21 protrudes out from the inside of frame 10. After an attachment part 22 of lock spring 18 wraps around a protrusion 23, an end part of the lock spring 18 is affixed to frame 10.

Arms 25, which hold terminal connection part 11 from the top and bottom, are provided integrally on both sides of shutter 13. A latching step part 26 at the end of arm 25 latches with the end surface of terminal connection part 11. Even when shutter 13 is being pushed by spring 15, it is stopped at a set position.

With this type of construction, when a compatible card 24a is inserted so that it contacts the inner wall on both sides of arm 25, both lock springs 18 are pushed open by both corners of compatible card 24a, which contacts contact parts 21 of lock spring 18. Hooking part 19 is released from hooking hole 20. When compatible card 24a is further pushed in, the end of compatible card 24a contacts and pushes in shutter 13. Connection terminals 12 protrude out from insertion holes 14 and are connected with the terminals (not shown) of compatible card 24a.

When an incompatible card 24b, which forms a space between it and the inner walls of arm 25, is inserted, the corners of both sides of incompatible card 24b do not touch contact parts 21 of lock spring 18. As a result, hooking part 19 does not release from hooking hole 20. Even if one corner of incompatible card 24b contacts a contact part 21 of one lock spring 18 and pushes open lock spring 18, at least one hooking part 19 is not removed from hooking hole 20. Thus, when incompatible card 24b is pushed further in, even if the end of card 24b contacts shutter 13, shutter 13 is not pushed in, and connection terminals 12 and the terminals (not shown) of incompatible card 24b do not connect.

In this manner, the insertion of incompatible card 24b is prevented, and the internal connection terminals 12 are protected.

There are several problems when using the multi-terminal connector of the prior art.

Lock spring 18 and spring 15 provided on frame 10 are attached and extend on both sides of frame 10. As a result, the overall width of the multi-terminal connector becomes that much wider. In addition, connection terminals 12 must be provided towards the center of terminal connecting part 11 by the amount of the width of springs 15 on both sides. The position of the terminals of card 24 which connect with connection terminals 12 must also be positioned towards the center of card 24 by the same amount.

Shutter 13 advances and retreats with connection terminals 12 which pass through pin insertion holes 14. As a result, connection terminal 12 must be longer than shutter 13, and connection terminals 12 may become bent or broken. In addition, this limits how short the depth of the multi-terminal connector can be.

After shutter 13 is returned to the original position by spring 15, shutter 13 must stop at a prescribed position in order to accurately match hooking hole 20 with hooking part 19. As a result, arms 25 on both sides must be made integrally with shutter 13 and must maintain a low position with latching step part 26. This is a complex construction.

### SUMMARY OF THE INVENTION

The present invention provides a multi-terminal connector equipped with a mechanism for protecting the internal terminals by preventing the insertion of incompatible insertion bodies. At the same time, extended parts on both sides are reduced as much as possible to achieve a smaller size. In addition, the present invention provides a multi-terminal connector which can be used regardless of the length of the connection terminal.

The present invention is a multi-terminal connector, wherein, by inserting or removing an insertion body into an insertion opening of a housing, the insertion body is electrically connected to or disconnected from a terminal connection part inside the insertion opening. The connector includes a shutter, which is normally impelled to a closed position and which is provided in front of terminal connection part. A lock spring which moves up and down by the insertion or removal of the insertion body is provided on both sides of housing. A latching piece, which can latch to and be released from a latching surface on each side of the lock spring, is provided at both ends of shutter. By inserting the insertion body into the insertion opening, both sides of the lock spring are deformed, and the latching surface of the lock spring and the latching piece of the shutter are released from a latched position. By further insertion of the insertion body, the shutter is pushed in, and the insertion body is connected to the terminal connection part.

With this construction, the multi-terminal connector has a shutter motion which is suitable for reliably connecting to and disconnecting from an internal terminal connection part when inserting or removing a compatible insertion body into an insertion opening of a housing.

According to another embodiment of the present invention, the present invention is a multi-terminal connector, wherein, by inserting or removing an insertion body into an insertion opening of a housing, the insertion body is electrically connected to or disconnected from a terminal connection part inside the insertion opening. The connector includes a shutter, which is normally impelled to a closed position and which is provided in front of terminal connection part. A lock spring moves up or down with the insertion or removal of the insertion body and is provided on an upper surface on both sides of the housing. A latching piece, which can latch to and be released from a latching surface on each side of the lock spring, is provided on both ends of the shutter. By inserting the insertion body into the insertion opening, the lock spring is deformed, and the latching surfaces of the lock spring and the latching pieces of the shutters are released from a latched position. By further insertion of the insertion body, the shutter is pushed in, and the insertion body is connected to the terminal connection part.

With this construction, the latching surface of the lock spring is positioned above the compatible insertion body. Space for attaching parts to the sides of the housing is not necessary, and the thickness of the sides can be a minimum thickness. The overall width of the multi-terminal connector can be as narrow as possible. In addition, the position of the connection pins in the terminal connection part is not limited. Furthermore, with the series of insertion motions of the insertion body into the insertion opening, both sides of the lock spring are deformed simultaneously, and the latch between the lock spring and the shutter is released. With the further insertion of the insertion body, the shutter is pushed open, and the insertion body is connected with the terminal connection part. Furthermore, when a non-standard insertion body is inserted into the insertion opening, as long as both sides of the lock spring are not deformed, the lock is not released. As a result, errors in insertion are prevented.

According to another embodiment of the present invention, the present invention is a multi-terminal connector, wherein, by inserting or removing an insertion body into an insertion opening of a housing, the insertion body is electrically connected to or disconnected from a terminal connection part inside the insertion opening. The connector includes a shutter, which is normally impelled to a closed position and which is provided in front of terminal connection part. A lock spring moves up or down with the insertion or removal of the insertion body and is provided on an upper surface on both sides of the housing. The lock spring includes a base part which is affixed to an upper surface of the housing and a flat spring part which extends on both sides of the base part. On each of the flat spring parts, there is a protruding part which is bent downward so that it protrudes into the insertion opening and in front of the shutter via a cut-out part on the upper. surface of the housing. On each of the flat spring parts, there is a latching surface which protrudes inward from a position on the upper surface of the housing on the side of the terminal connection part relative to the protruding part. When the protruding part protrudes inside the insertion opening, the latching surface and the latching piece on both ends of the shutter are engaged. By insertion of an insertion body, the protruding part is pushed upward, and the latching surface and latching piece are disengaged.

With this construction, the overall width of the multi-terminal connector is as narrow as possible. In addition, when removing the compatible insertion body, as long as the flat spring part is lowered after the shutter is made upright, the positioning of the return of the shutter is not necessary, and the construction is simplified.

According to another embodiment of the present invention, a pressed-in piece on both ends of a base part is pressed into a pressed-in opening, which is formed at the back on both ends of an upper surface of a housing. A protruding part is formed by having a downward curving portion at the front end of a flat spring part which extends from both ends of the base part. On an inside surface between the protruding part and the base part, a latching surface is formed as a groove which is approximately perpendicular to the direction of insertion of an insertion body. With this construction, the strength of the lock spring itself is increased. When the latching surface of the lock spring is engaged with the latching piece of the shutter, the lock spring does not become deformed even when pushed by the force of the shutter. The lock spring operates reliably for a long period of time. In addition, the assembly of the lock spring and the shutter onto the housing becomes easier.

According to another embodiment of the present invention, a pressed-in piece on both ends of a base part is pressed into a pressed-in opening, which is formed at the front on both ends of an upper surface of a housing. On an inside surface at the back end of a flat spring part which extends from both ends of the base part, a latching surface is formed as a groove which is approximately perpendicular to the direction of insertion of an insertion body. Between the latching surface and the base part, a protruding part is formed by having a downward curving portion of the flat spring part. With this construction, the fulcrum in the connection portion between the flat spring part and the base part is towards the front. The movement of the point of engagement between the latching piece and the latching surface is large relative to the vertical movement of the protruding part. A reliable latching and releasing is achieved.

According to another embodiment of the present invention, a protruding piece for preventing twist is formed on an upper surface of a housing, and an outside surface of the twist-preventing protruding piece contacts an inside surface of a flat spring part. With this construction, when an incompatible insertion body is inserted into the insertion opening and pushes the shutter with force, even when a force from the latching piece acts on the flat spring part to bend it inward, the inside of the flat spring part contacts the outside of the twist-preventing protruding piece, and this absorbs the force and prevents twist.

According to another embodiment of the present invention, a shutter, which is impelled to a closed position, is opened by rotation in opposition to a spring by insertion of an insertion body into an insertion opening. By removing the insertion body, the shutter is returned to a closed position by the spring. With this construction, the shutter is opened and closed by pivoting in front of the connection pins. As a result, the connection pins can be short and are not bent or broken. In addition, the depth of the multi-terminal connector is shortened.

### BRIEF DESCRIPTION OF THE FIGURES

FIG. 1 is a plan view showing a multi-terminal connector with a portion removed, according to an embodiment of the present invention;

FIG. 2 is a longitudinal cross-section showing a condition when a compatible insertion body is being inserted into the multi-terminal connector of FIG. 1;

FIG. 3 is a longitudinal cross-section showing a condition when compatible insertion body is inserted further into the multi-terminal connector of FIG. 1;

FIG. 4 is an exploded perspective view of the multi-terminal connector of FIG. 1;

FIG. 5 is a perspective view of a lock spring of a multi-terminal connector, according to another embodiment of the present invention; and

FIG. 6 is a plan view of a multi-terminal connector of the prior art with a portion removed.

### DESCRIPTION OF THE PREFERRED EMBODIMENTS

In the present invention, there is a shutter 34 provided in an insertion opening 32 of a housing 30. Shutter 34 swings open and close by an insertion body 37. In the usual state, shutter 34 is locked in a closed position by latching a latching surface 46 on both sides of lock spring 33 with a latching piece 49 on both sides of shutter 34. When a compatible insertion body 37a is inserted, flat springs 45 positioned in the upper part on both sides of compatible insertion body 37a are lifted, and the lock is released to allow for the insertion of compatible insertion body 37a. Even if one of the locks is released, as long as both locks are not simultaneously released, shutter 34 remains closed, and an incompatible insertion body 37b is prevented from being inserted.

Flat spring part 45 of lock spring 33 is positioned on the upper surface on both sides of housing 30. Extension areas on both sides of housing 30 are eliminated, and the width is made narrower. In addition, because shutter 34 opens and closes by swinging, connection pins 44 can be short. Therefore, the multi-terminal connector is made smaller both in the width direction and in the depth direction.

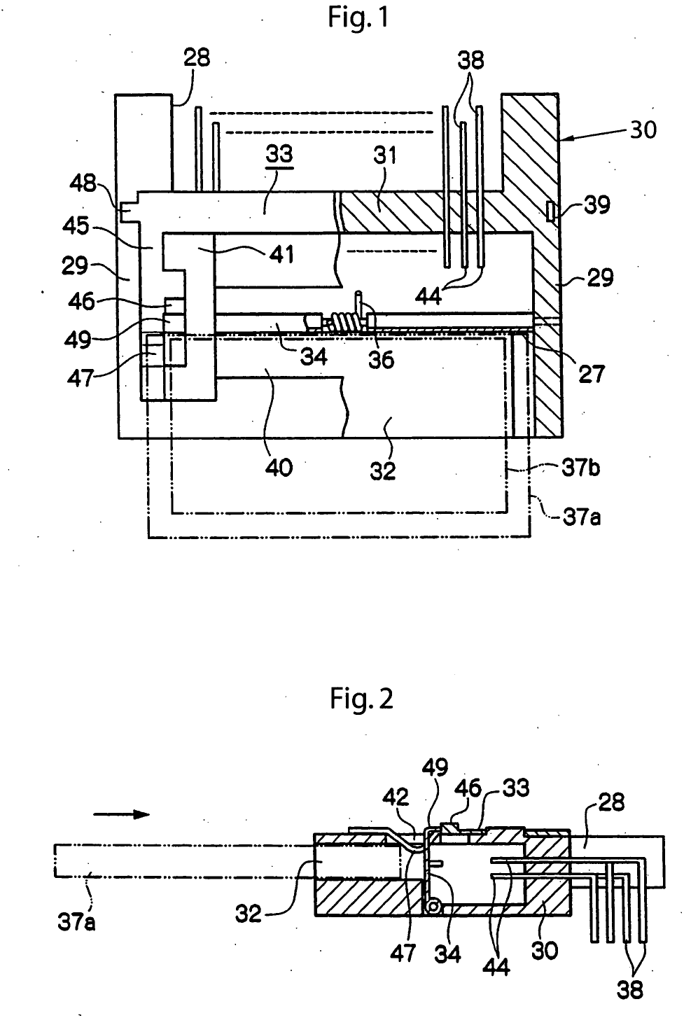

Referring to FIGS. 1-4, a multi-terminal connector according to an embodiment of the present invention is described.

Housing 30 is formed of an insulated material such as plastic or the like. Housing 30 is a box-shape that is flat and thin. An insertion opening 32 is formed on the front side of housing 30. Sides 29 on both sides of insertion opening 32 are for inserting a compatible insertion body 37a. There is no lock mechanism or other parts attached to sides 29. As a result, sides 29 are thin, and the width of housing 30 is made as narrow as possible.

In the depth portion of the interior of housing 30, there is an integrally-formed terminal connection part 31. A plurality of connection pins 44 pass through and are attached to terminal connection part 31 and protrude out to the inside of insertion opening 32. Terminal parts 38 of connection pins 44 protrude out into cavity 28 at the back of housing 30 and are bent downward for connecting to a printed board or the like.

The top plate of housing 30 has a horizontal upper opening part 40. There are cut-outs 42 on both sides of upper opening part 40 and somewhat inside from side part 29. In addition, towards the back and on both sides of the top plate of housing 30, there is a pressed-in opening 39 which is for holding a lock spring 33. A C-shaped twist-preventing protruding piece 41 is formed integrally on the top plate. Twist-preventing piece 41 straddles upper opening 40.

Lock spring 33 is a flat spring material, such as a thin metal plate. In order to construct a base part 51 and a flat spring part 45 on both sides, lock spring 33 is cut into a C-shape. A downward pressed-in piece 48 is formed on both sides of base part 51. At the end of flat spring part 45, there is a protruding part 47 which is bent into a downward U-shape. In addition, on the inside of flat spring part 45, there is an integrally formed latching surface 46 which is perpendicular to the length direction of flat spring part 45.

Pressed-in piece 48 of lock spring 33 is pressed into pressed-in opening 39 of housing 30. Thereupon, the inner surface of flat spring parts 45 on both sides and the outer surface of twist-preventing protruding piece 41 come into contact. In addition, protruding part 47 of flat spring part 45 engages with cut-out 42 of housing 30, and a portion of the lower end of protruding part 47 protrudes to the inside of insertion opening 32.

Inside insertion opening 32, a shutter 34 which can open and close is attached. At the bottom of housing 30, a support shaft 35 inserted from a shaft hole 43 passes through bearing part 52 of shutter 34. Furthermore, support shaft 35 passes through a spring 36 which is placed in cut-out 50 of shutter 34 and supports spring 36 in a freely rotating manner. In addition, on both sides of shutter 34, there is an integrally formed latching piece 49 which is bent into a reverse L-shape which extends upward. Shutter 34 which is installed inside housing 30 normally stands upright and contacts a stopper 27 by the action of spring 36. In addition, latching piece 49 of shutter 34 contacts latching surface 46 of lock spring 33.

The action of the above construction will be described.

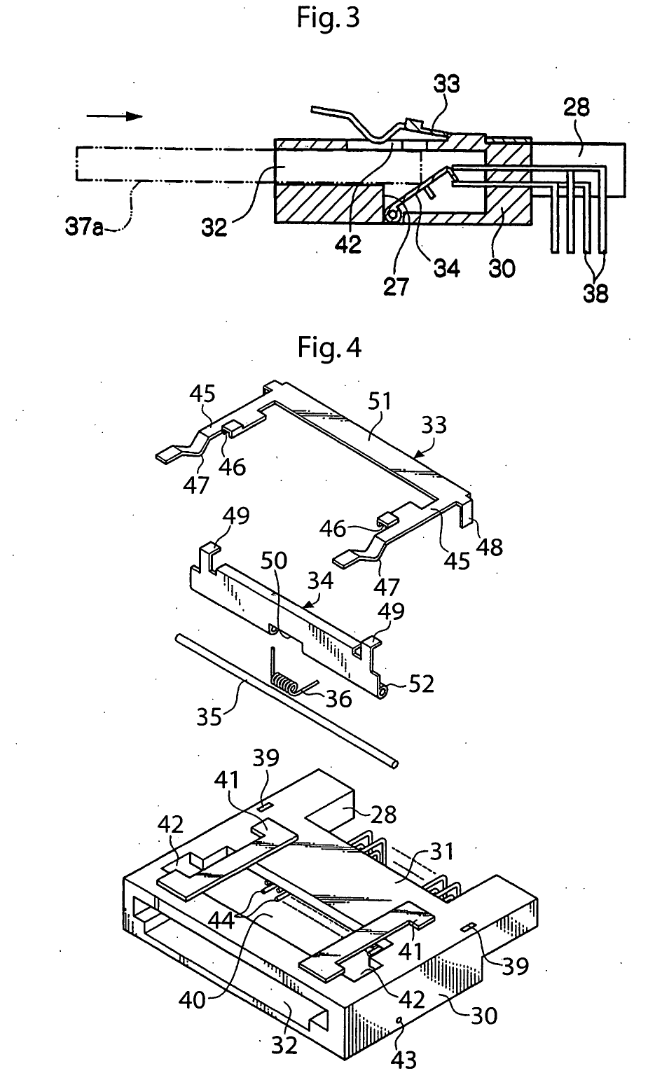

Referring to FIG. 1, a compatible insertion body 37a is inserted into insertion opening 32 of housing 30, and compatible insertion body 37a is inserted while contacting both sides of the inside of side parts 29. Referring to FIG. 2, the leading edge of compatible insertion body 37a contacts the two protruding parts 47 protruding from the lower end of cut-outs 42. By further inserting compatible insertion body 37a, the two protruding parts 47 are pushed up simultaneously. The two flat spring parts 45 are lifted upward with the connection part to base part 51 as the fulcrum. Thereupon, latching surface 46 which is integral with flat spring part 45 is also lifted up, and the latch with latching piece 49 is released. When latching piece 49 is released from latching surface 46, as shown in FIG. 3, shutter 34 is pushed forward in opposition of spring 36 by the insertion of compatible insertion body. 37a. Compatible insertion body 37a is pushed to terminal connection part 31 and is electrically connected with connection pins 44.

When compatible insertion body 37a is removed slightly from housing 30, it is released from terminal connection part 31. When it is removed further, shutter 34 returns to its upright position. When removed further, flat spring part 45 is lowered on its own due to its spring property. Latching surface 46 latches with latching piece 49, and protruding part 47 is lowered inside insertion opening 32 and returns to the original condition.

Next, when an incompatible insertion body 37b is inserted into insertion opening 32, its leading edge does not contact protruding part 47 protruding at the lower end of cut-out 42 and comes directly into contact with shutter 34. Thereupon, because latching surface 46 is still engaged with latching piece 49, shutter 34 does not go forward, and incompatible insertion body 37b cannot be inserted further.

In addition, if during the insertion of incompatible insertion body 37b, incompatible insertion body 37b is not inserted into the middle of insertion opening 32 but is inserted at an angle with one side touching the inside of one side part 29, as shown in FIG. 2, the leading edge of incompatible insertion body 37b contacts one protruding part 47 which is protruding downward from cut-out 42. Protruding part 47 is lifted, and flat spring part 45 is lifted upward with the connecting portion with base part 51 as the fulcrum. The latch of latching surface 46 and latching piece 49 is released. But because the leading edge of incompatible insertion body 37b does not contact the other protruding part 47, the latch between the other latching surface 46 and latching piece 49 is not released. As a result, even if the leading edge of incompatible insertion body 37b contacts shutter 34, shutter 34 does not move forward, and further insertion of incompatible insertion body 37b is not possible.

When inserting an incompatible insertion body 37b, if shutter 34 is pushed with force by the leading edge of incompatible insertion body 37b, because latching piece 49 is engaged with latching surface 46, flat spring part 45 is pushed in and there is a force for bending both flat spring parts 45 inward. The inside of flat spring part 45 contacts the outside of twist preventing protruding piece 41, and the force for bending flat spring part 45 is absorbed, and twist is prevented.

Because flat spring part 45 and latching surface 46 of lock spring 33 are positioned above compatible insertion body 37a, space for attaching parts to side part 29 is not necessary, and the width of side part 29 can be minimized. The overall width of the multi-terminal connector is made as narrow as possible. In addition, the positions for connection pins 44 in terminal connection part 31 are not limited.

Because shutter 34 opens and closes by pivoting in front of connection pins 44, the length of connection pins 44 is shorter so that they are not bent or broken. In addition, the depth of multi-terminal connector can be shortened.

When removing compatible insertion body 37a, as long as the timing is such that flat spring part 45 is lowered after shutter 34 becomes upright, positioning of shutter 34 is not necessary, and the construction is simplified.

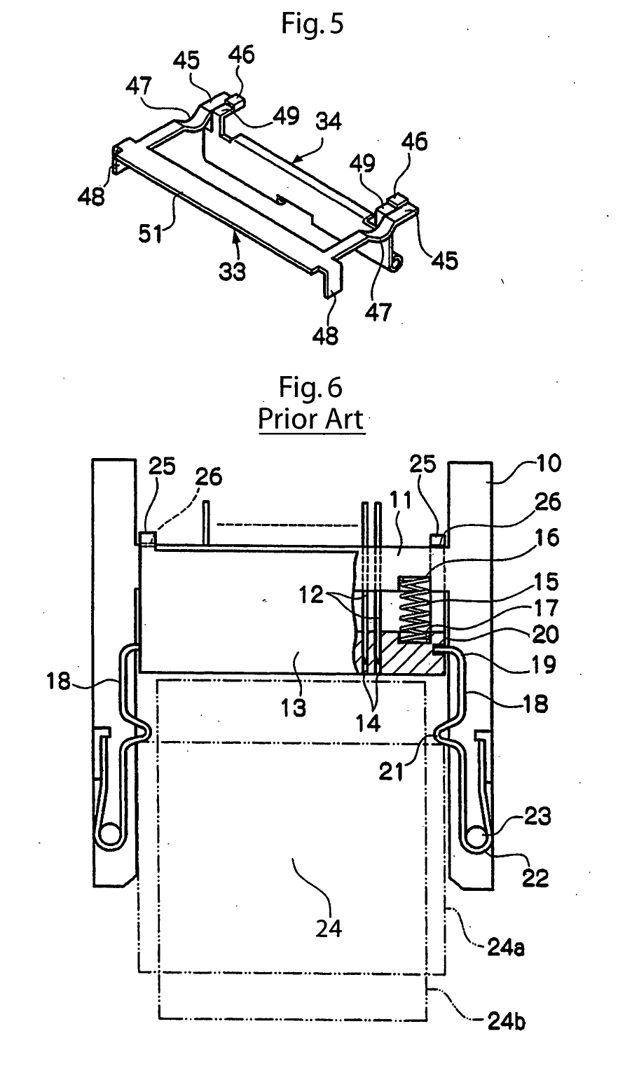

FIG. 5 shows another embodiment of the present invention. In the embodiment shown in FIGS. 1-4, base part 51 of lock spring 33 is retained by a pressed-in opening 39 at the back of housing 30. In contrast, with the embodiment of the invention shown in FIG. 5, base part 51 of lock spring 33 is retained by a pressed-in opening 39 at the front of housing 30. With this construction, the fulcrum of the connecting portion between flat spring part 45 and base part 51 is in front. As a result, the movement of the point of engagement of latching piece 49 and latching surface 46 is large relative to the vertical movement of protruding part 47.

What is claimed is:

1. A multi-terminal connector, wherein by inserting or removing an insertion body into an insertion opening of a housing, said insertion body is electrically connected with or disconnected from a terminal connection part inside said insertion opening, said connector comprising:
a shutter, impelled to a closed position, provided in front of said terminal connection part;
a lock spring, deformed by at least one of an insertion and removal of said insertion body, provided on said housing;
a latching piece, latching with and releasing from a latching surface of said lock spring, provided at an end of said shutter;
wherein by inserting said insertion body into said insertion opening to a first position, said lock spring is deformed, and said latching surface of said lock spring and said latching piece of said shutter is released from a latched position, and
wherein by further insertion of said insertion body to a second position, said shutter is pushed in, and said insertion body is connected to said terminal connection part.

2. A multi-terminal connector, wherein by inserting or removing an insertion body into an insertion opening of a housing, said insertion body is electrically connected with or disconnected from a terminal connection part inside said insertion opening, said connector comprising:
a shutter, impelled to a closed position, provided in front of said terminal connection part;
a lock spring, moving in one of an up and down direction with at least one of the insertion and removal of said insertion body, provided over both sides of an upper surface of said housing;
a latching surface on each side of said lock spring;
a latching piece, provided on each end of said shutter, latching with and releasable from one of said latching surfaces of said lock spring;
wherein by inserting said insertion body into said insertion opening to a first position, said lock spring is deformed and said latching surfaces of said lock spring and said latching pieces of said shutter are released from a latched position, and
wherein by further insertion of said insertion body to a second position, said shutter is pushed in, and said insertion body is connected to said terminal connection part.

3. A multi-terminal connector, wherein by inserting or removing an insertion body into an insertion opening of a housing, said insertion body is electrically connected with or disconnected from a terminal connection part inside said insertion opening, said connector comprising:
a shutter, impelled to a closed position, provided in front of said terminal connection part;
a lock spring, moving in one of an up and down direction with at least one of the insertion and removal of said insertion body, provided over both sides of an upper surface of said housing;
said lock spring comprising:
a base part which is affixed to said upper surface of said housing, and
a flat spring part extending from each side of said base part;
a protruding part on each of said flat spring parts, each of said protruding parts being bent downward to protrude into said insertion opening and in front of said shutter via at least one cut-out part on said upper surface of said housing; and
a latching surface on each of said flat spring parts, each of said latching surfaces protruding inward from said upper surface of said housing on a side of said terminal connection part relative to said protruding parts;
a latching piece on each end of said shutter;
wherein said latching surfaces and said latching pieces engage when said protruding parts protrude inside said insertion opening; and
wherein by insertion of said insertion body, said protruding parts are pushed upward and said latching surfaces and said latching pieces disengage.

4. A multi-terminal connector as described in claim 3, further comprising:
an opening formed towards a back end on each of said sides of said upper surface of said housing;
a pressed-in piece on each of said sides of said base part of said lock spring pressed into each of said openings on said upper surface of said housing;
wherein each of said protruding parts has a downward curving portion at a front end of said respective flat spring part; and
wherein each of said latching surfaces is formed on an inside surface of said lock spring between said protruding parts and said base part as a groove which is approximately perpendicular to a direction of insertion of said insertion body.

5. A multi-terminal connector as described in claim 3, further comprising:
an opening formed towards a front end on each of said sides of said upper surface of said housing;
a pressed-in piece on each of said sides of said base part of said lock spring pressed into each of said openings on said upper surface of said housing;
wherein each of said latching surfaces is formed on an inside surface of said lock spring at a back end of said flat spring part extending from both said sides of said base part as a groove which is approximately perpendicular to a direction of insertion of said insertion body; and
wherein between said latching surfaces and said base part, each of said protruding parts is a downward curving portion of said flat spring part.

6. A multi-terminal connector as described in claim 2, further comprising:
a twist-preventing protruding piece formed on said upper surface of said housing; and
an outside surface of said twist-preventing protruding piece contacts an inside surface of a flat spring part of said lock spring.

7. A multi-terminal connector as described in claim 1, wherein:
said shutter, which is impelled to said closed position, is opened by rotation in opposition to a spring by insertion of said insertion body into said insertion opening; and
by removing said insertion body, said shutter is returned to said closed position by said spring.

8. A multi-terminal connector as described in claim 3, further comprising:
a twist-preventing protruding piece formed on said upper surface of said housing; and
an outside surface of said twist-preventing protruding piece contacts an inside surface of said flat spring part of said lock spring.

9. A multi-terminal connector as described in claim 4, further comprising:
a twist-preventing protruding piece formed on said upper surface of said housing; and
an outside surface of said twist-preventing protruding piece contacts said inside surface of said flat spring part of said lock spring.

10. A multi-terminal connector as described in claim 2, wherein:
said shutter, which is impelled to said closed position, is opened by rotation in opposition to a spring by insertion of said insertion body into said insertion opening; and
by removing said insertion body, said shutter is returned to said closed position by said spring.

11. A multi-terminal connector as described in claim 3, wherein:
said shutter, which is impelled to said closed position, is opened by rotation in opposition to a spring by insertion of said insertion body into said insertion opening; and
by removing said insertion body, said shutter is returned to said closed position by said spring.

12. A multi-terminal connector as described in claim 4, wherein:
said shutter, which is impelled to said closed position, is opened by rotation in opposition to a spring by insertion of said insertion body into said insertion opening; and
by removing said insertion body, said shutter is returned to said closed position by said spring.

13. A multi-terminal connector as described in claim 5, wherein:
said shutter, which is impelled to said closed position, is opened by rotation in opposition to a spring by insertion of said insertion body into said insertion opening; and
by removing said insertion body, said shutter is returned to said closed position by said spring.

14. A multi-terminal connector as described in claim 6, wherein:
said shutter, which is impelled to said closed position, is opened by rotation in opposition to a spring by insertion of said insertion body into said insertion opening; and
by removing said insertion body, said shutter is returned to said closed position by said spring.

15. A multi-terminal connector, wherein by inserting or removing an insertion body into an insertion opening of a housing, said insertion body is electrically connected with or disconnected from a terminal connection part inside said insertion opening, said connector comprising:
a shutter, impelled to a closed position, provided in front of said terminal connection part;
a lock spring, moving in one of an up and down direction with at least one of the insertion and removal of said insertion body, provided on an upper surface of said housing;
said lock spring comprising:
a base part which is affixed to said upper surface of said housing, and
at least one flat spring part extending from said base part;
at least one protruding part on said flat spring part, said at least one protruding part being bent downward to protrude into said insertion opening and in front of said shutter via at least one cut-out part on said upper surface of said housing; and
at least one latching surface on said flat spring part, said at least one latching surface protruding inward from said upper surface of said housing on a side of said terminal connection part relative to said at least one protruding part;
at least one latching piece being provided on said shutter;
wherein said at least one latching surface and said at least one latching piece engage when said at least one protruding part protrudes inside said insertion opening; and
wherein by insertion of said insertion body, said at least one protruding part is pushed upward and said at least one latching surface and said at least one latching piece disengage.
